(19) United States
(12) Patent Application Publication
(10) Pub. No.: US 2025/0072462 A1
(43) Pub. Date: Mar. 6, 2025

(54) MICROWAVE CRISPY ENROBED OR WRAPPED FOOD

(71) Applicant: SFC GLOBAL SUPPLY CHAIN, INC., Marshall, MN (US)

(72) Inventors: Joseph Chou, Anaheim, CA (US); Brenda Bauer, Garvin, MN (US); Bonita Hinze, Prior Lake, MN (US); Mina Cha, Fullerton, CA (US)

(21) Appl. No.: 18/820,632

(22) Filed: Aug. 30, 2024

Related U.S. Application Data
(60) Provisional application No. 63/580,216, filed on Sep. 1, 2023.

(51) Int. Cl. A23P 20/20; A21D 13/31

(52) U.S. Cl. CPC A23P 20/20; A21D 13/31

(57) ABSTRACT

Microwavable crispy wrapped or enrobed foods that have a crispy exterior texture and retain moisture in an interior filling after microwaving. The crispy exterior is formed from a batter that may comprise soft wheat cake flour, oxidized tapioca starch, and rice flour. The wrapped or enrobed foods may be cooked, frozen, and reheated in the microwave to produce a crispy product.

### CROSS-REFERENCE TO RELATED APPLICATION

This application claims benefit of U.S. Provisional Application Ser. No. 63/580,216 filed Sep. 1, 2023, which is hereby incorporated by reference in its entirety.

### FIELD

The present disclosure is related to compositions, methods, and kits for microwavable crispy wrapped or enrobed foods. The disclosed compositions result in a prepared food that is crispy on the outside with a moist or tender filling.

### BACKGROUND

The convenience of microwaved foods has made them a popular part of consumer diets. However, the convenience of microwaved foods is countered by challenges related to texture and taste that can impact the overall eating experience. Microwave heating can lead to uneven distribution of heat, resulting in unevenly cooked or reheated foods. This can leave some parts of the food overheated, while others may remain underheated or even cold. Microwaving can contribute additionally to an unpleasant texture, causing once-crispy items to become soggy, limp, tough, and/or hard, diminishing the appeal of the wrapped or enrobed foods. This phenomenon is exacerbated in multi-component foods with differing compositions.

It is against this background that the present disclosure is made.

### SUMMARY

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

Disclosed herein is a microwavable crispy dumpling comprising a dumpling wrapper comprising dough; a batter comprising one or more of soft wheat cake flour, oxidized tapioca starch, and rice flour; and a filling.

Also disclosed herein is a method of making a microwavable crispy dumpling, the method comprising mixing ingredients to form a dough; preparing a dumpling wrapper from the dough; filling the dumpling wrapper; forming a dumpling; and coating the dumpling with a batter, the batter comprising at least one of soft wheat cake flour, oxidized tapioca starch, and rice flour.

Also disclosed herein is a batter for providing a crispy texture, the batter comprising soft wheat cake flour, oxidized tapioca starch, and rice flour; and a filling; wherein the batter coats an enrobed or wrapped food product.

Also disclosed herein is an enrobed or wrapped food product comprising a batter comprising one or more of soft wheat cake flour, oxidized tapioca starch, and rice flour; a dough; and a filling.

Also disclosed herein is a method of preparing an enrobed or wrapped food product for consumption, the method comprising placing a frozen enrobed or wrapped food product in a microwave; microwaving the frozen enrobed or wrapped food product for about 10 seconds to about 15 minutes; wherein the enrobed or wrapped food product after microwaving is heated throughout and has a crisp outer texture.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1A is a side view of a crispy wrapped or enrobed dumpling.

FIG. 1B is a top view of a crispy wrapped or enrobed dumpling.

FIG. 2 is a perspective view of a crispy wrapped or enrobed burrito.

FIG. 3 is a perspective view of a crispy wrapped or enrobed egg roll.

FIG. 4 is a perspective view of a crispy folded and unsealed food.

FIG. 5 is a graph showing the peaks measured by a TAXT texture analyzer as described in Example 1.

FIG. 6A is a graph showing the average initial peak count as described in Example 2.

FIG. 6B is a graph showing the average initial drop off force as described in Example 2.

### DETAILED DESCRIPTION

As used herein, weight percent (wt. %), percent by weight, % by weight, and the like are synonyms that refer to the concentration of a substance as the weight of that substance divided by the total weight of the composition and multiplied by 100.

As used herein, the term “about” modifying the quantity of an ingredient in the compositions of the invention or employed in the methods of the invention refers to variation in the numerical quantity that can occur, for example, through typical measuring and liquid handling procedures used for making use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about,” the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

Wrapped or enrobed foods often comprise a dough exterior with an interior filling that may be savory or sweet. The dough may be any suitable dough that can be rolled, sheeted, extruded, stretched, folded, crimped, pressed, or otherwise manipulated to partially enclose or form a sealed pocket around the interior filling.

A wrapped or enrobed food can be cooked in a variety of ways, such as boiling, steaming, pan-frying, deep-frying, air-frying, or baking. All of these methods provide even cooking and heating of the wrapped or enrobed food. However, these methods are time consuming and require kitchen equipment and supplies, such as pots and pans, ovens, utensils, and cooking oil. For consumers, customers, or companies that wish to produce wrapped or enrobed foods without the time or equipment, a quick and simple alternative is to use a microwave to cook or reheat the wrapped or enrobed foods.

Microwaving wrapped or enrobed foods, or microwaving any food product, often does not produce a desirable product though. Microwaves are electromagnetic waves that cause dipolar rotation and ionic conduction of molecules in the food, which generate heat. These electromagnetic waves are unevenly distributed throughout the microwave cavity. Differences in the food composition result in different heating. Uneven distribution of the electromagnetic waves along with the varying composition of the food can cause some areas of the food to be overheated and others underheated.

Additionally, microwave cooking can accelerate moisture migration from one component in a food to another component. This can lead to degradation of the desired texture of the multi-component food. For example, multi-component foods that are meant to have a crispy exterior, like fried items, may become soggy and/or tough in the microwave due to moisture migration from the filling into the cooked crispy exterior. The filling can become dry from loss of moisture at the same time the cooked crispy exterior becomes soggy and/or tough.

Microwave cooking suffers from further issues, including inconsistent heating profiles as a result of packaging. It is common practice to utilize a susceptor to optimize the heating profile; however, that can add cost and/or complexity. In addition, a poorly designed susceptor can trap moisture generated during heating in close proximity to a crispy food exterior and exacerbate textural changes.

Microwave cooking can also cause textural changes in food, especially in foods wrapped or enrobed in dough. Structural changes within the dough often reduce crispiness and increase sogginess, toughness, hardness, and chewiness.

Described herein are compositions, methods, and kits for microwavable crispy wrapped or enrobed foods that overcome the issues described above with microwaved foods. The wrapped or enrobed foods disclosed herein have three zones: a moist interior filling, a wrapper or enrobed dough, and a crispy batter coating. The resulting product has a crispy exterior with a moist interior filling and is evenly cooked and heated.

The wrapped or enrobed foods described herein have moisture management properties such that the exterior remains crispy while the interior filling retains moistness. In some examples, the moist interior filling is designed to retain moistness during microwave heating because the wrapper or enrobed dough component is acting as a moisture buffer zone between the filling and the crispy exterior. The crispy exterior is formed from an outer batter layer, which is designed to create an enhanced crispy exterior compared to a wrapped or enrobed food without a batter. The outer batter layer may have properties so that moisture migrates from the batter during cooking and reheating to enhance the crispy outer coating on the wrapped or enrobed foods.

In some examples, the wrapped or enrobed foods are formed from a partially or fully wrapped or enrobed dough that is filled and coated in a batter. In some examples, the dough, batter, or both may comprise soft wheat cake flour, oxidized tapioca starch, rice flour, or combinations thereof.

In some examples, the soft wheat cake flour may be finely milled and comprise about 6-10% protein. Without wishing to be bound by theory, it is believed that the soft wheat cake flour contributes to a tender texture of the wrapped or enrobed foods due to lower gluten development compared to some other flours. Additionally, soft wheat cake flour has a higher starch content, which aids in modulating moisture balance of the dough or batter, thus achieving the desired moisture balance in the resulting wrapped or enrobed foods during microwaving.

In some examples, the dough, batter, or both may also comprise oxidized tapioca starch. Without wishing to be bound by theory, it is believed that the oxidized tapioca starch provides a tender crispiness to the crispy exterior zone of the wrapped or enrobed foods. Oxidized tapioca starch is tapioca starch that has undergone chemical or physical processing to oxidize it, such as treatment with chlorine, such as sodium hypochlorite. Oxidized tapioca starch can withstand acidic conditions and prolonged storage for products that have a long shelf life, such as frozen and packaged foods. Oxidized tapioca starch provides thickening and binding properties. Additionally, oxidized tapioca starch is capable of holding water to modulate moisture balance, such as retaining moisture that is otherwise lost during microwave cooking. It also has improved stability in freeze-thaw cycles as compared to regular, non-oxidized tapioca starch. This is particularly beneficial in frozen foods that may undergo many freeze-thaw cycles as they are produced and travel through the distribution chain to consumers or customers. Oxidized tapioca starch may also provide a more palatable texture than regular, non-oxidized tapioca starch because of its branched structure.

In some examples, the dough, batter, or both may also comprise rice flour. In some examples, the rice flour is finely milled. Without wishing to be bound by theory, it is believed that rice flour reduces oil pickup of the fried dough or batter. Rice flour also provides ideal binding properties in the dough or batter due to the starch composition. Additionally, rice flour also provides a lighter crispy texture in the final wrapped or enrobed foods product after cooking.

In some examples, the batter, dough, or both as disclosed herein may comprise other ingredients including, but not limited to, other forms of flour including wheat flour, wheat starch, barley flour, buckwheat flour, corn flour, corn meal, corn starch, corn masa, spelt flour, soy flour, millet flour, flaxseed flour, oat flour, potato flour, potato starch, potato meal, quinoa flour, brown rice flour, white rice flour, rice starch, rye flour, sorghum flour, cassava flour, tapioca flour, tapioca starch, legume flours including, but not limited to, chickpea flour, lentil flour, pea flour, fava bean flour, mung bean flour, vegetable flours including, but not limited to, cauliflower, yam, broccoli, pumpkin, spinach, squash, beet, carrot, potato, and combinations thereof. In some examples, the batter, dough, or both as disclosed herein may comprise other ingredients such as grains or grain flours, including, but not limited to, wheat, whole grain wheat, oat, barley, rye, rice, corn, cornmeal, quinoa, millet, sorghum, triticale, sesame, flax, hemp, poppy, chia, buckwheat, spelt, sprouted grains, and combinations thereof. In some examples, the batter, dough, or both as disclosed herein may comprise other ingredients including, but not limited to leaveners such as baking soda, baking powder, yeast, cultures, sourdough starter, egg whites, ammonium bicarbonate, and combinations thereof.

In some examples, the batter, dough, or both may comprise other ingredients including, but not limited to, salt, sea salt, granulated sugar, brown sugar, confectioner's sugar, honey, maple syrup, molasses, agave nectar, corn syrup, high fructose corn syrup, fructose, dextrose, trehalose, turbinado sugar, date sugar, gums including, but not limited to, xanthan gum, gum arabic, guar gum, starches, celluloses, oils including, but not limited to, vegetable oil, seed oil, olive oil, canola oil, rapeseed oil, sunflower seed oil, peanut oil, coconut oil, soybean oil, almond oil, walnut oil, hazelnut oil, avocado oil, grapeseed oil, sesame oil, palm oil, fats including, but not limited to, butter, vegetable shortening, lard, animal fats, additional ingredients including, but not limited to, yeast extract, herbs, spices, tomato, garlic, pepper, honey, mustard, barbeque, ranch, onion, bacon, cheddar cheese, parmesan, bread crumbs, panko crumbs, organic acids, preservatives, proteins including, but not limited to, protein isolates, protein concentrates, egg, whey, soy, lentil, pea, and combinations thereof.

In some examples, the batter comprises soft wheat cake flour in an amount of about 5 wt. % to about 50 wt. % of the total weight of the batter. In some examples, the batter comprises soft wheat cake flour in an amount of about 5 wt. % to about 45 wt. %, about 5 wt. % to about 40 wt. %, about 5 wt. % to about 35 wt. %, about 5 wt. % to about 30 wt. %, about 5 wt. % to about 25 wt. %, about 5 wt. % to about 20 wt. %, about 5 wt. % to about 15 wt. % about 5 wt. % to about 10 wt. %, about 10 wt. % to about 50 wt. %, about 15 wt. % to about 50 wt. %, about 20 wt. % to about 50 wt. %, about 25 wt. % to about 50 wt. %, about 30 wt. % to about 50 wt. %, about 35 wt. % to about 50 wt. %, about 40 wt. % to about 50 wt. %, or about 45 wt. % to about 50 wt. % of the total weight of the batter. In some examples, the batter does not comprise soft wheat cake flour.

In some examples, the batter comprises oxidized tapioca starch in an amount of about 5 wt. % to about 25 wt. % of the total weight of the batter. In some examples, the batter comprises oxidized tapioca starch in an amount of about 5 wt. % to about 20 wt. %, about 5 wt. % to about 15 wt. %, about 5 wt. % to about 10 wt. %, about 10 wt. % to about 25 wt. %, about 15 wt. % to about 25 wt. %, or about 20 wt. % to about 25 wt. % of the total weight of the batter. In some examples, the batter does not comprise oxidized tapioca starch.

In some examples, the batter comprises rice flour in an amount of about 2 wt. % to about 40 wt. % of the total weight of the batter. In some example, the batter comprises rice flour in an amount of about 2 wt. % to about 35 wt. %, about 2 wt. % to about 30 wt. %, about 2 wt. % to about 25 wt. %, about 2 wt. % to about 20 wt. %, about 2 wt. % to about 15 wt. %, about 2 wt. % to about 10 wt. %, about 2 wt. % to about 5 wt. %, about 5 wt. % to about 40 wt. %, about 10 wt. % to about 40 wt. %, about 15 wt. % to about 40 wt. %, about 20 wt. % to about 40 wt. %, about 25 wt. % to about 40 wt. %, about 30 wt. % to about 40 wt. %, or about 35 wt. % to about 40 wt. % of the total weight of the batter. In some examples, the batter does not comprise rice flour.

In some examples, the batter comprises any salt disclosed herein in an amount of about 0.01 wt. % to about 10 wt. % of the total weight of the batter. In some examples, the batter comprises salt in an amount of about 0.01 wt. % to about 8 wt. %, about 0.01 wt. % to about 6 wt. %, about 0.01 wt. % to about 5 wt. %, about 0.01 wt. % to about 2 wt. %, about 0.01 wt. % to about 1 wt. %, about 0.01 wt. % to about 0.1 wt. %, about 0.1 wt. % to about 10 wt. %, about 1 wt. % to about 10 wt. %, about 2 wt. % to about 10 wt. %, about 5 wt. % to about 10 wt. %, about 6 wt. % to about 10 wt. %, or about 8 wt. % to about 10 wt. % of the total weight of the batter. In some examples, the batter does not comprise salt.

In some examples, the batter comprises any leavener disclosed herein in an amount of about 0.01 wt. % to about 5 wt. % of the total weight of the batter. In some examples, the batter comprises a leavener in an amount of about 0.01 wt. % to about 4 wt. %, about 0.01 wt. % to about 3 wt. %, about 0.01 wt. % to about 2 wt. %, about 0.01 wt. % to about 1 wt. %, about 0.01 wt. % to about 0.1 wt. %, about 0.1 wt. % to about 5 wt. %, about 1 wt. % to about 5 wt. %, about 2 wt. % to about 5 wt. %, about 3 wt. % to about 5 wt. %, or about 4 wt. % to about 5 wt. % of the total weight of the batter. In some examples, the batter does not comprise leavener.

In some examples, the batter comprises yeast extract in an amount of about 0.01 wt. % to about 5 wt. % of the total weight of the batter. In some examples, the batter comprises yeast extract in an amount of about 0.01 wt. % to about 4 wt. %, about 0.01 wt. % to about 3 wt. %, about 0.01 wt. % to about 2 wt. %, about 0.01 wt. % to about 1 wt. %, about 0.01 wt. % to about 0.1 wt. %, about 0.1 wt. % to about 5 wt. %, about 1 wt. % to about 5 wt. %, about 2 wt. % to about 5 wt. %, about 3 wt. % to about 5 wt. %, or about 4 wt. % to about 5 wt. % of the total weight of the batter. In some examples, the batter does not comprise yeast extract.

In some examples, the batter comprises any gum disclosed herein in an amount of about 0.001 wt. % to about 5 wt. % of the total weight of the batter. In some examples, the batter comprises a gum in an amount of about 0.001 wt. % to about 4 wt. %, about 0.001 wt. % to about 3 wt. %, about 0.001 wt. % to about 2 wt. %, about 0.001 wt. % to about 1 wt. %, about 0.001 wt. % to about 0.1 wt. %, about 0.001 wt. % to about 0.01 wt. %, about 0.01 wt. % to about 5 wt. %, about 0.1 wt. % to about 5 wt. %, about 1 wt. % to about 5 wt. %, about 2 wt. % to about 5 wt. %, about 3 wt. % to about 5 wt. %, or about 4 wt. % to about 5 wt. % of the total weight of the batter. In some examples, the batter does not comprise any gums.

In some examples, the batter comprises any sugar disclosed herein in an amount of about 0.001 wt. % to about 5 wt. % of the total weight of the batter. In some examples, the batter comprises sugar in an amount of about 0.001 wt. % to about 4 wt. %, about 0.001 wt. % to about 3 wt. %, about 0.001 wt. % to about 2 wt. %, about 0.001 wt. % to about 1 wt. %, about 0.001 wt. % to about 0.1 wt. %, about 0.001 wt. % to about 0.01 wt. %, about 0.01 wt. % to about 5 wt. %, about 0.1 wt. % to about 5 wt. %, about 1 wt. % to about 5 wt. %, about 2 wt. % to about 5 wt. %, about 3 wt. % to about 5 wt. %, or about 4 wt. % to about 5 wt. % of the total weight of the batter. In some examples, the batter does not comprise sugar.

In some examples, the batter comprises panko or any other bread crumb in an amount of about 0.5 wt. % to about 5 wt. % of the total weight of the batter. In some examples, the batter comprises panko or other bread crumb in an amount of about 0.5 wt. % to about 4 wt. %, about 0.5 wt. % to about 3 wt. %, about 0.5 wt. % to about 2 wt. %, about 0.5 wt. % to about 1 wt. %, about 0.5 wt. % to about 5 wt. %, about 1 wt. % to about 5 wt. %, about 2 wt. % to about 5 wt. %, about 3 wt. % to about 5 wt. %, or about 4 wt. % to about 5 wt. % of the total weight of the batter. In some examples, the batter does not comprise panko or any other bread crumb.

In some examples, the batter comprises water in an amount of about 20 wt. % to about 80 wt. % of the total weight of the batter. In some examples, the batter comprises water in an amount of about 20 wt. % to about 75 wt. %, about 20 wt. % to about 70 wt. %, about 20 wt. % to about 65 wt. %, about 20 wt. % to about 60 wt. %, about 20 wt. % to about 55 wt. %, about 20 wt. % to about 50 wt. %, about 20 wt. % to about 45 wt. %, about 20 wt. % to about 40 wt. %, about 20 wt. % to about 35 wt. %, about 20 wt. % to about 30 wt. %, about 20 wt. % to about 25 wt. %, about 25 wt. % to about 80 wt. %, about 30 wt. % to about 80 wt. %, about 35 wt. % to about 80 wt. %, about 40 wt. % to about 80 wt. %, about 45 wt. % to about 80 wt. %, about 50 wt. % to about 80 wt. %, about 55 wt. % to about 80 wt. %, about 60 wt. % to about 80 wt. %, about 65 wt. % to about 80 wt. %, about 70 wt. % to about 80 wt. %, or about 75 wt. % to about 80 wt. % of the total weight of the batter. In some examples, the batter does not comprise water.

In some examples, the batter may also comprise any of the other ingredients disclosed herein.

Described herein is also a dough. In some examples, the dough comprises any flour disclosed herein in an amount of about 20 wt. % to about 90 wt. % of the total weight of the dough. In some examples, the flour is an enriched wheat flour. In some examples, the dough comprises flour in an amount of about 20 wt. % to about 85 wt. %, about 20 wt. % to about 80 wt. %, about 20 wt. % to about 75 wt. %, about 20 wt. % to about 70 wt. %, about 20 wt. % to about 65 wt. %, about 20 wt. % to about 60 wt. %, about 20 wt. % to about 55 wt. %, about 20 wt. % to about 50 wt. %, about 20 wt. % to about 45 wt. %, about 20 wt. % to about 40 wt. %, about 20 wt. % to about 35 wt. %, about 20 wt. % to about 30 wt. %, about 20 wt. % to about 25 wt. %, about 25 wt. % to about 90 wt. %, about 30 wt. % to about 90 wt. %, about 35 wt. % to about 90 wt. %, about 40 wt. % to about 90 wt. %, about 45 wt. % to about 90 wt. %, about 50 wt. % to about 90 wt. %, about 55 wt. % to about 90 wt. %, about 60 wt. % to about 90 wt. %, about 65 wt. % to about 90 wt. %, about 70 wt. % to about 90 wt. %, about 75 wt. % to about 90 wt. %, about 80 wt. % to about 90 wt. %, or about 85 wt. % to about 90 wt. % of the total weight of the dough. In some examples, the dough does not comprise flour.

In some examples, the dough comprises any oil disclosed herein in an amount of about 0.1 wt. % to about 10 wt. % of the total weight of the dough. In some examples, the oil is a soybean oil. In some examples, the dough comprises oil in an amount of about 0.1 wt. % to about 8 wt. %, about 0.1 wt. % to about 6 wt. %, about 0.1 wt. % to about 5 wt. %, about 0.1 wt. % to about 2 wt. %, about 0.1 wt. % to about 1 wt. %, about 1 wt. % to about 10 wt. %, about 2 wt. % to about 10 wt. %, about 5 wt. % to about 10 wt. %, about 6 wt. % to about 10 wt. %, or about 8 wt. % to about 10 wt. % of the total weight of the dough. In some examples, the dough does not comprise oil.

In some examples, the dough comprises water in an amount of about 5 wt. % to about 50 wt. % of the total weight of the dough. In some examples, the dough comprises water in an amount of about 5 wt. % to about 45 wt. %, about 5 wt. % to about 40 wt. %, about 5 wt. % to about 35 wt. %, about 5 wt. % to about 30 wt. %, about 5 wt. % to about 25 wt. %, about 5 wt. % to about 20 wt. %, about 5 wt. % to about 15 wt. % about 5 wt. % to about 10 wt. %, about 10 wt. % to about 50 wt. %, about 15 wt. % to about 50 wt. %, about 20 wt. % to about 50 wt. %, about 25 wt. % to about 50 wt. %, about 30 wt. % to about 50 wt. %, about 35 wt. % to about 50 wt. %, about 40 wt. % to about 50 wt. %, or about 45 wt. % to about 50 wt. % of the total weight of the dough. In some examples, the dough does not comprise water.

In some examples, the dough comprises any salt disclosed herein in an amount of about 0.01 wt. % to about 5 wt. % of the total weight of the dough. In some examples, the dough comprises salt in an amount of about 0.01 wt. % to about 4 wt. %, about 0.01 wt. % to about 3 wt. %, about 0.01 wt. % to about 2 wt. %, about 0.01 wt. % to about 1 wt. %, about 0.01 wt. % to about 0.1 wt. %, about 0.1 wt. % to about 5 wt. %, about 1 wt. % to about 5 wt. %, about 2 wt. % to about 5 wt. %, about 3 wt. % to about 5 wt. %, or about 4 wt. % to about 5 wt. % of the total weight of the dough. In some examples, the dough does not comprise salt.

In some examples, the dough may also comprise any of the other ingredients disclosed herein.

In some examples, the batter and dough described herein are each produced by mixing the above-described ingredients to fully incorporate the ingredients to a desired consistency to form the batter and dough, respectively. In some examples, all of the batter or dough ingredients are mixed together until fully combined to form the batter or dough that are both homogenous and completely incorporated. In some examples, some or all of the above ingredients are mixed together to form a batter, while some or all of the above ingredients are mixed together to form a dough. Compositions and methods for both doughs and batters are disclosed herein.

In some examples, the ingredients in the batter or the dough, respectively, are mixed together in stages or all at once. For example, all of the dry ingredients of the batter may be mixed together and fully incorporated, and then the wet ingredients of the batter added in. Likewise, all of the dry ingredients of the dough may be mixed together and fully incorporated, and then the wet ingredients of the dough added in. In some examples, the ingredients are mixed together for about 30 seconds to about 40 minutes, about 30 seconds to about 35 minutes, about 30 seconds to about 30 minutes, about 30 seconds to about 25 minutes, about 30 seconds to about 20 minutes, about 30 seconds to about 15 minutes, about 30 seconds to about 10 minutes, about 30 seconds to about 8 minutes, about 30 seconds to about 5 minutes, about 30 seconds to about 3 minutes, about 30 seconds to about 2 minutes, about 30 seconds to about 1 minute, about 1 minute to about 40 minutes, about 2 minutes to about 40 minutes, about 3 minutes to about 40 minutes, about 5 minutes to about 40 minutes, about 8 minutes to about 40 minutes, about 10 minutes to about 40 minutes, about 15 minutes to about 40 minutes, about 20 minutes to about 40 minutes, about 25 minutes to about 40 minutes, about 30 minutes to about 40 minutes, or about 35 minutes to about 40 minutes. In some examples, the dough is mixed for about 5 minutes to about 20 minutes. In some examples, the batter is mixed for about 20 minutes to about 40 minutes.

In some examples, after the batter is mixed, there may be continued agitation to ensure batter consistency and to prevent batter separation.

A Bostwick consistometer is used to measure the consistency and flow of liquids and semi-liquids, such as a batter. The consistometer can provide information such as consistency, viscosity, and flow rate.

In some examples, the batter (once mixed and homogenous) has a consistency measurement of about 5 cm to 30 cm as measured by a Bostwick consistometer at 30 seconds. In some examples, the batter has a consistency measurement of about 5 cm to about 29 cm, about 5 cm to about 28 cm, about 5 cm to about 27 cm, about 5 cm to about 26 cm, about 5 cm to about 25 cm, about 5 cm to about 24 cm, about 5 cm to about 23 cm, about 5 cm to about 22 cm, 5 cm to about 21 cm, about 5 cm to about 20 cm, about 5 cm to about 19 cm, about 5 cm to about 18 cm, about 5 cm to about 17 cm, about 5 cm to about 16 cm, about 5 cm to about 15 cm, about 5 cm to about 14 cm, about 5 cm to about 13 cm, about 5 cm to about 12 cm, about 5 cm to about 11 cm, about 5 cm to about 10 cm, about 5 cm to about 9 cm, about 5 cm to about 8 cm, about 5 cm to about 7 cm, about 5 cm to about 6 cm, about 6 cm to about 30 cm, about 7 cm to about 30 cm, about 8 cm to about 30 cm, about 9 cm to about 30 cm, about 10 cm to about 30 cm, about 11 cm to about 30 cm, about 12 cm to about 30 cm, about 13 cm to about 30 cm, about 14 cm to about 30 cm, about 15 cm to about 30 cm, about 16 cm to about 30 cm, about 17 cm to about 30 cm, about 18 cm to about 30 cm, about 19 cm to about 30 cm, about 20 cm to about 30 cm, about 21 cm to about 30 cm, about 22 cm to about 30 cm, about 23 cm to about 30 cm, about 24 cm to about 30 cm, about 25 cm to about 30 cm, about 26 cm to about 30 cm, about 27 cm to about 30 cm, about 28 to about 30 cm, or about 29 cm to about 30 cm as measured by a Bostwick consistometer at 30 seconds. In some examples, the consistency is from about 15 cm to about 17 cm as measured by a Bostwick consistometer at 30 seconds.

After the dough is mixed, it is formed. The dough is shaped by rolling, sheeting, spreading, kneading, pressing, extruding, or any other suitable type of physical manipulation. In some examples, the formed dough is substantially a circle. In other examples, the formed dough is any other suitable polygonal shape such as an oval, square, or rectangle.

Once the formed dough described herein has been produced, the wrapped or enrobed food may be assembled. In some examples, dough is used as a dumpling wrapper to encase a filling. In some examples, dough is used as an egg roll wrapper to encase a filling. In some examples, a dough is used as a tortilla to encase a filling. In other examples, any other suitable formed dough is used to encase a filling.

The thickness of the formed dough is varied to minimize toughness and wrapper awareness (i.e., a consumer noticing an undesirable texture, taste, thickness, or consistency of the wrapper) during consumption of the microwavable wrapped or enrobed food. In some examples, the formed dough is a dumpling wrapper. In some examples, the formed dough is an egg roll wrapper. In some examples, the formed dough is a tortilla. In some examples, the formed dough is in the shape of a pizza crust, a chalupa shell, a naan, a pita, or a calzone.

In some examples, the thickness of the formed dough is about 0.2 mm to about 12.0 mm. In some examples, the thickness of the formed dough is about 0.2 mm to about 10 mm, about 0.2 mm to about 8 mm, about 0.2 mm to about 5 mm, about 0.2 mm to about 3 mm, about 0.2 mm to about 2 mm, about 0.2 mm to about 1.5 mm, about 0.2 mm to about 1 mm, about 0.2 to about 0.5 mm, about 0.5 mm to about 12 mm, about 1 mm to about 12 mm, about 1.5 mm to about 12 mm, about 2 mm to about 12 mm, about 3 mm to about 12 mm, about 5 mm to about 12 mm, about 8 mm to about 12 mm, or about 10 mm to about 12 mm. mm In some examples, the thickness of the formed dough is about 0.4 mm to about 0.6 mm.

The filling may be comprised of various ingredients. In some examples, the filling may comprise a protein source such as chicken, turkey, duck, or any other poultry meat, beef, pork, or any other red meat, tofu, shrimp, crab, lobster, fish, shellfish, eggs, sausage, pepperoni, ham, bacon, cheese, vegetarian meat substitutes, vegan meat substitutes, beans, chickpeas, legumes, nuts, or any other meat or non-meat protein source, and combinations thereof. In some examples, the filling comprises vegetables, herbs, or fruits, such as bean sprouts, bamboo, water chestnuts, cabbage, onion, green onion, carrot, corn, cucumbers, jalapeno, peppers, green beans, broccoli, potato, garlic, bok choy, radish, ginger or any other vegetable, basil, mint, cilantro, chives, oregano, or any other herbs, pineapple, pumpkin, apple, cherry, blueberry, peach, mango, or any other fruits, and combinations thereof. In some examples, the filling may comprise starchy foods such as rice, glass noodles, macaroni, or any other starchy foods. In some cases, the filling may comprise a sauce such as pizza sauce, salsa, alfredo, sweet & sour, teriyaki, soy, mustard, alfredo, peanut, buffalo, horseradish, ranch, adobo, gochujang, chimichurri, tahini, barbeque, sour cream, or any other sauce. In some examples, the filling comprises sugar, salt, black pepper, yeast extracts, flavorings, seasonings, oils, flours, grains, starches, fibers, gums, celluloses, soy protein, whey protein, pea protein, water, or any of the other ingredients described in this disclosure.

In some examples, the selected filling is combined with a source of fiber, such as oat fiber, citrus fiber, tomato fiber, apple fiber, carrot fiber, brown rice fiber, quinoa fiber, barley fiber, wheat fiber, or combinations thereof. In some examples, the source of fiber is oat fiber. In some examples, the filling is mixed with oat fiber in an amount of about 0.25 wt. % to about 4 wt. % of the total weight of the filling. In some examples, the filling is mixed with oat fiber in an amount of about 0.25 wt. % to about 3.5 wt. %, about 0.25 wt. % to about 3 wt. %, about 0.25 wt. % to about 2.5 wt. %, about 0.25 wt. % to about 2 wt. %, about 0.25 wt. % to about 1.5 wt. %, about 0.25 wt. % to about 1 wt. %, about 0.25 wt. % to about 0.5 wt. %, about 0.5 wt. % to about 4 wt. %, about 1 wt. % to about 4 wt. %, about 1.5 wt. % to about 4 wt. %, about 2 wt. % to about 4 wt. %, about 2.5 wt. % to about 4 wt. %, about 3 wt. % to about 4 wt. %, or about 3.5 wt. % to about 4 wt. % of the total weight of the filling.

In some examples, starch is added to the filling to modulate moisture. In some examples, the filling includes gums, starches, celluloses, or combinations thereof. In some examples, the filling comprises a starch, such as tapioca starch, in an amount of about 0.1 wt. % to about 10 wt. % of the total weight of the filling. In some examples, the filling comprises starch, such as tapioca starch, in an amount of about 0.1 wt. % to about 8 wt. %, about 0.1 wt. % to about 5 wt. %, about 0.1 wt. % to about 2 wt. %, about 0.1 wt. % to about 1 wt. %, about 1 wt. % to about 10 wt. %, about 2 wt. % to about 10 wt. %, about 5 wt. % to about 10 wt. %, or about 8 wt. % to about 10 wt. % of the total weight of the filling. In other examples, the filling does not include any gums, starches, celluloses, or combinations thereof.

The filling ingredients may be mixed to form the filling. In some examples, the ingredients (any of those described herein) may be added sequentially and mixed. In some examples, a first group of ingredients may be added and mixed for about 30 seconds to about 5 minutes. A second group of ingredients may be added and mixed for about 30 seconds to about 5 minutes. In some examples, all of the ingredients are mixed together at once for about 30 seconds to about 10 minutes. Any order of combination or mixing time disclosed herein is contemplated. The mixing step may comprise one step or multiple steps.

To assemble the wrapped or enrobed foods, a suitable amount of the filling is placed on a formed dough. In some examples, the amount of filling used in a wrapped or enrobed foods wrapper depends on a ratio of the filling to the wrapper.

In some examples, water or some other liquid or food adhesive is placed along the outer border of the formed dough, wherein the formed dough partially or fully encases the filling. In some examples, the edges may be pressed, pinched, pleated, crimped, or otherwise sealed to encase the filling inside of the formed dough.

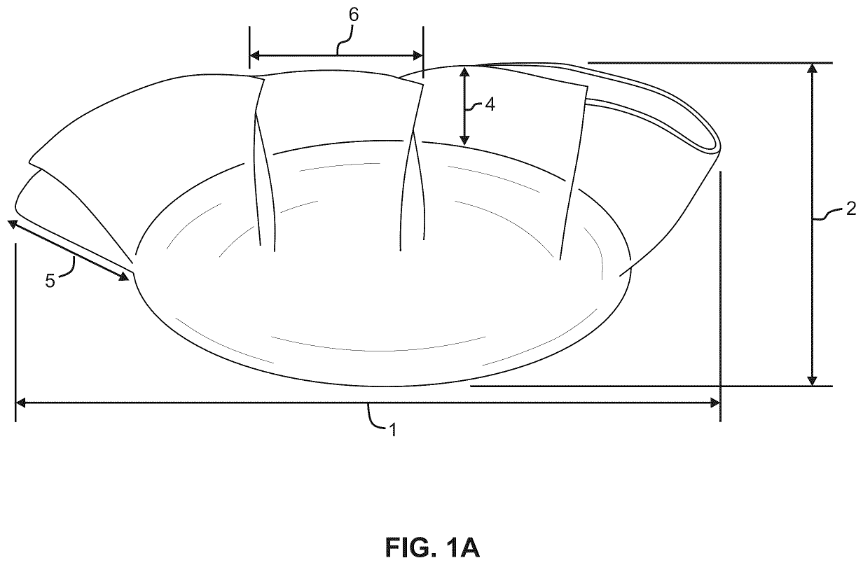

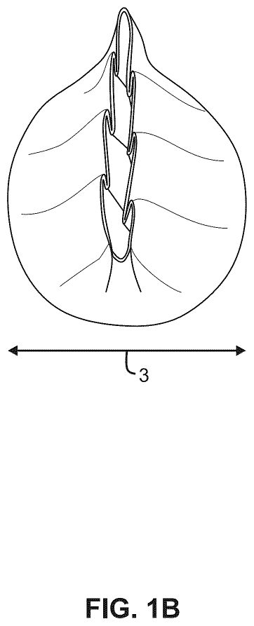

FIGS. 1A and 1B show an example of a fully formed dumpling comprising the sealed dumpling wrapper with filling inside. In FIG. 1A, the length of the dumpling is represented by measurement 1, the height is represented by measurement 2, the top dimension of the wings is represented by measurement 4, the side dimension of the wings is represented by measurement 5, the crease gap is represented by measurement 6. In FIG. 1B, the width of the dumpling is represented by measurement 3.

In some examples, the length of the dumpling, represented by measurement 1, is the measurement of the longest dimension of the dumpling as measured from the farthest point of one wing to the farthest point of the other wing of the dumpling. In some examples, the length of the dumpling ranges from 25 mm to 70 mm. In some examples, the length of the dumpling is about 25 mm to about 65 mm, about 25 mm to about 60 mm, about 25 mm to about 55 mm, about 25 mm to about 50 mm, about 25 mm to about 45 mm, about 25 mm to about 40 mm, about 25 mm to about 35 mm, about 25 mm to about 30 mm, about 30 mm to about 70 mm, about 35 mm to about 70 mm, about 40 mm to about 70 mm, about 45 mm to about 70 mm, about 50 mm to about 70 mm, about 55 mm to about 70 mm, about 60 mm to about 70 mm, or about 65 mm to about 70 mm. In some examples, the length of the dumpling is about 50 mm to about 60 mm.

In some examples, the height of the dumpling, represented by measurement 2, is measured from the base of the dumpling to the highest point of the wings of the dumpling. In some examples, the height of the dumpling ranges from 10 mm to 50 mm. In some examples, the height of the dumpling is about 10 mm to about 45 mm, about 10 mm to about 40 mm, about 10 mm to about 35 mm, about 10 mm to about 30 mm, about 10 mm to about 25 mm, about 10 mm to about 20 mm, about 10 mm to about 15 mm, about 15 mm to about 50 mm, about 20 mm to about 50 mm, about 25 mm to about 50 mm, about 30 mm to about 50 mm, about 35 mm to about 50 mm, about 40 mm to about 50 mm, or about 45 mm to about 50 mm. In some examples, the height of the dumpling is about 25 mm to about 35 mm.

In some examples, the width of the dumpling, represented by measurement 3, is measured from a top view of the dumpling as shown in FIG. 1B, and widest part of the filled portion of the dumpling is measured. The width of the dumpling may be reflective of the volume of the dumpling. In some examples, the width of the dumpling is about 10 mm to about 50 mm. In some examples, the width of the dumpling is about 10 mm to about 45 mm, about 10 mm to about 40 mm, about 10 mm to about 35 mm, about 10 mm to about 30 mm, about 10 mm to about 25 mm, about 10 mm to about 20 mm, about 10 mm to about 15 mm, about 15 mm to about 50 mm, about 15 mm to about 45 mm, about 15 mm to about 40 mm, about 15 mm to about 35 mm, about 15 mm to about 30 mm, about 15 mm to about 25 mm, or about 15 mm to about 20 mm.

In some examples, the wing top measurement, represented by measurement 4 in FIG. 1A, is measured from the top of the filled portion of the dumpling to the top of the creased wings. In some examples, the wing top measurement is about 2 mm to about 20 mm. In some examples, the wing top measurement is about 2 mm to about 19 mm, about 2 mm to about 18 mm, about 2 mm to about 17 mm, about 2 mm to about 16 mm, about 2 mm to about 15 mm, about 2 mm to about 14 mm, about 2 mm to about 13 mm, about 2 mm to about 12 mm, about 2 mm to about 11 mm, about 2 mm to about 10 mm, about 2 mm to about 9 mm, about 2 mm to about 8 mm, about 2 mm to about 7 mm, about 2 mm to about 6 mm, about 2 mm to about 5 mm, about 2 mm to about 4 mm, about 2 mm to about 3 mm, about 3 mm to about 20 mm, about 4 mm to about 20 mm, about 5 mm to about 20 mm, about 6 mm to about 20 mm, about 7 mm to about 20 mm, about 8 mm to about 20 mm, about 9 mm to about 20 mm, about 10 mm to about 20 mm, about 11 mm to about 20 mm, about 12 mm to about 20 mm, about 13 mm to about 20 mm, about 14 mm to about 20 mm, about 14 mm to about 20 mm, about 15 mm to about 20 mm, about 16 mm to about 20 mm, about 17 mm to about 20 mm, about 18 mm to about 20 mm, or about 19 mm to about 20 mm. In some examples, the wing top measurement is about 5 mm to about 10 mm.

In some examples, the wing side measurement, represented by measurement 5 in FIG. 1A, is measured from the distance between the filled portion of the dumpling and the sealed edge of the dumpling on either side of the dumpling. In some examples, the wing side measurement is about 5 mm to about 25 mm. In some examples, the wing side measurement is about 5 mm to about 24 mm, about 5 mm to about 23 mm, about 5 mm to about 22 mm, about 5 mm to about 21 mm, about 5 mm to about 20 mm, about 5 mm to about 19 mm, about 5 mm to about 18 mm, about 5 mm to about 17 mm, about 5 mm to about 16 mm, about 5 mm to about 15 mm, about 5 mm to about 14 mm, about 5 mm to about 13 mm, about 5 mm to about 12 mm, about 5 mm to about 11 mm, about 5 mm to about 10 mm, about 5 mm to about 9 mm, about 5 mm to about 8 mm, about 5 mm to about 7 mm, about 5 mm to about 6 mm, about 6 mm to about 25 mm, about 7 mm to about 25 mm, about 8 mm to about 25 mm, about 9 mm to about 25 mm, about 10 mm to about 25 mm, about 11 mm to about 25 mm, about 12 mm to about 25 mm, about 13 mm to about 25 mm, about 14 mm to about 25 mm, about 15 mm to about 25 mm, about 16 mm to about 25 mm, about 17 mm to about 25 mm, about 18 mm to about 25 mm, about 19 mm to about 25 mm, about 20 mm to about 25 mm, about 21 mm to about 25 mm, about 22 mm to about 25 mm, about 23 mm to about 25 mm, or about 24 mm to about 25 mm. In some examples, the wing side measurement is about 12 mm to about 14 mm.

In some examples, the dumpling may include a crease gap, represented by measurement 6 in FIG. 1A. In other examples, the dumpling does not include a crease gap, such as if the dumpling is a pierogi or other dumpling or dumpling-like food product that is not creased. In examples where the dumpling includes a crease gap, the crease gap is measured from the side of each crease to the other side of that same crease in the folded portion of the dumpling, as shown by the line labeled 6 in FIG. 1A. In some examples, the crease gap is about 5 mm to about 30 mm. In some examples, the crease gap is about 5 mm to about 25 mm, about 5 mm to about 20 mm, about 5 mm to about 15 mm, about 5 mm to about 10 mm, about 10 mm to about 30 mm, about 15 mm to about 30 mm, about 20 mm to about 30 mm, or about 25 mm to about 30 mm. In some examples, the crease gap is about 10 mm to about 20 mm.

In some examples, the number of creases in the top of the dumpling varies. The number of creases is dependent on the size of the dumpling, the amount of filling in the body of the dumpling, the thickness of the wrapper, the size of the unmolded wrapper, and the moisture of the wrapper. The number of creases in a dumpling may be 2-12 per dumpling. In some examples, a dumpling comprises 2 creases to 10 creases, 2 creases to 8 creases, 2 creases to 5 creases, 2 creases to 4 creases, 2 creases to 3 creases, 3 creases to 12 creases, 4 creases to 12 creases, 5 creases to 12 creases, 8 creases to 12 creases, or 10 creases to 12 creases. In some examples, the dumpling does not comprise creases.

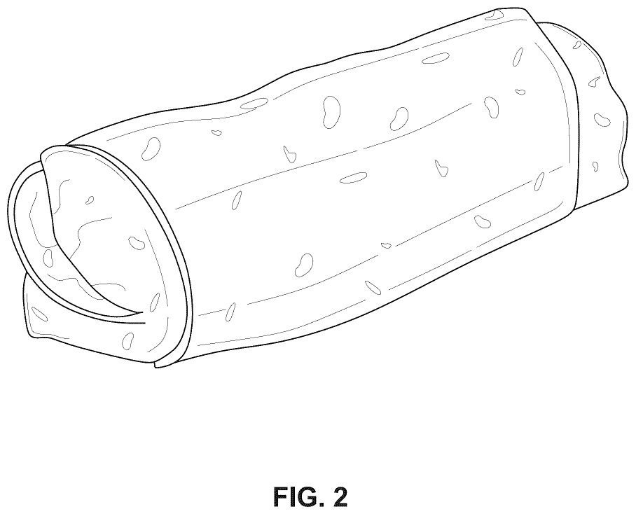

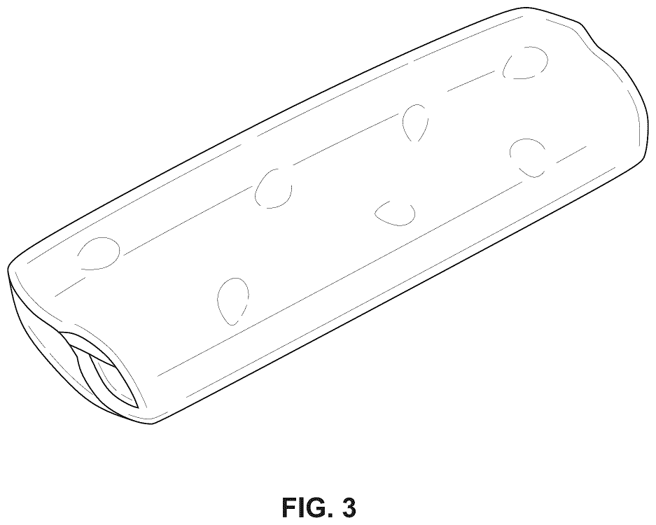

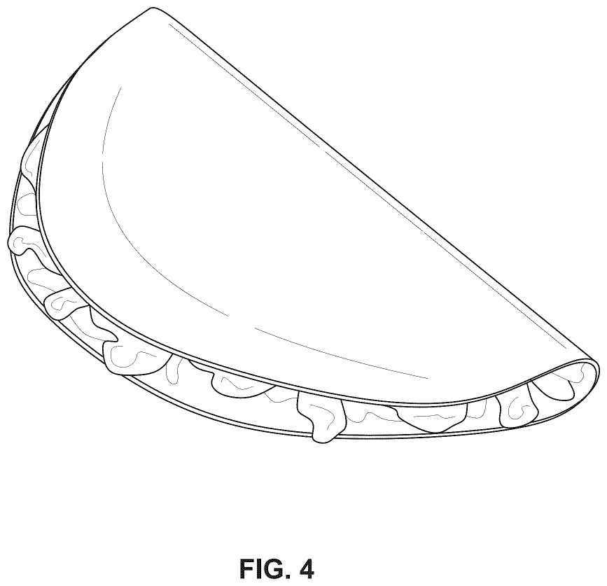

In some examples, the filling in a formed dough may be coated with the batter, as described herein, to form an outer layer. In some examples, the filling in a formed dough is coated in the batter, as described herein, to form an outer layer. In some examples, the resulting product is a filled dumpling wrapper with a batter exterior. In some examples, the resulting product is a filled egg roll wrapper with a batter exterior, an example of which is shown in FIG. 3. In some examples, the resulting product is a filled tortilla with a batter exterior, an example of which is shown in FIG. 2. In some examples, the resulting product is a folded tortilla or bread with a batter exterior, an example of which is shown in FIG. 4.

As discussed herein, the wrapped or enrobed food may be any suitable food product that is wrapped or enrobed in a dough. Some examples include burritos, egg rolls, and folded and unsealed products like tacos or folded sandwiches. Other examples include, but are not limited to, wontons, quesadillas, taquitos, flautas, samosas, enchiladas, empanadas, chimichangas, pierogies, ravioli, manicotti, calzones, bao, cabbage rolls, tamales, dim sum, dumplings, potstickers, gyoza, arancini, and pasty. Any wrapped or enrobed food product comprising a dough is contemplated herein.

The enrobed or wrapped food product that is coated in batter may be cooked using any suitable method, including but not limited to boiling; steaming; frying, such as pan-frying, deep-frying, air-frying, or vacuum frying; baking, such as conventional convection, broiling, toasting, or roasting; electromagnetic frequency, such as microwaving, infrared, or radio frequency; induction; conduction; pressure cooking; vacuum cooking; and combinations thereof. The cooking method selected to cook the product may affect the final composition of the wrapped or enrobed food. In some examples, the assembled product may be fried with a source of oil or melted fat, such as canola oil, soybean oil, vegetable oil, cottonseed oil, corn oil, avocado oil, olive oil, rapeseed oil, grapeseed oil, almond oil, or any other suitable oil, shortening, lard, tallow, or any other suitable fat. In some examples, the cooked product has a crispy exterior with a moist interior filling.

In some examples, the wrapped or enrobed food is frozen before cooking. In some examples, the wrapped or enrobed food may be partially cooked and then frozen. In some examples, the wrapped or enrobed food may be fully cooked and then frozen. In some examples, the wrapped or enrobed food is uncooked, partially cooked, or fully cooked and refrigerated.

In some examples, the wrapped or enrobed food is reheated or cooked in the microwave by the end user. In some examples, the wrapped or enrobed food may be microwaved on dishware or absorbent paper, such as a napkin or paper towel. In some examples, the wrapped or enrobed food may also be microwaved in packaging provided with the wrapped or enrobed food when the consumer purchases the wrapped or enrobed food. In some examples, a susceptor is used. In other examples, the wrapped or enrobed food is microwaved free of a susceptor. In a preferred embodiment, a susceptor is not required to achieve the desired tender crisp exterior and moist filling interior.

In some examples, prior to microwaving, frozen wrapped or enrobed food may have an average internal product temperature of about −5° F. to about 20° F. After microwaving, the wrapped or enrobed food may be heated to an average internal temperature of about 140° F. to about 210° F.

The wrapped or enrobed food may be microwaved for about 10 seconds to about 15 minutes, about 10 seconds to about 12 minutes, about 10 seconds to about 10 minutes, about 10 seconds to about 8 minutes, about 10 seconds to about 7 minutes, about 10 seconds to about 6 minutes, about 10 seconds to about 5 minutes, about 10 seconds to about 4 minutes, about 10 seconds to about 3 minutes, about 10 seconds to about 2 minutes, about 10 seconds to about 1 minute, about 10 seconds to about 30 seconds, about 30 seconds to about 15 minutes, about 1 minute to about 15 minutes, about 2 minutes to about 15 minutes, about 3 minutes to about 15 minutes, about 4 minutes to about 15 minutes, about 5 minutes to about 15 minutes, about 6 minutes to about 15 minutes, about 7 minutes to about 15 minutes, about 8 minutes to about 15 minutes, about 10 minutes to about 15 minutes, or about 12 minutes to about 15 minutes.

The time that the wrapped or enrobed food is microwaved will depend on the quantity of wrapped or enrobed food being microwaved at once to achieve the desired internal temperature.

In some examples, the wrapped or enrobed food is microwaved on 100% power, 90% power, 80% power, 70% power, 60% power, 50% power, 40% power, 30% power, 20% power, 10% power, or any combination thereof. In some examples, the wrapped or enrobed food may be microwaved for a combination of power levels. For example, the wrapped or enrobed food may be microwaved for one period of time at 100% power and then microwaved for a second period of time at 50% power. Any combination of power levels and time intervals are contemplated.

In some examples, after the wrapped or enrobed food is microwaved, there is a resting period where the wrapped or enrobed food sit undisturbed before consumption. In some examples, the resting time is from about 30 seconds to about 5 minutes.

Also disclosed herein are kits for microwavable wrapped or enrobed foods. In some examples, the kit comprises a microwavable packaging for cooking and/or heating the wrapped or enrobed foods. In some examples, the kit also comprises one or more microwavable crispy wrapped or enrobed food and one or more sauces.

In some examples, the frozen wrapped or enrobed food is heated in an air fryer. Prior to air-frying, the wrapped or enrobed food may have an average internal product temperature of about −5° F. to about 20° F. In some examples, the wrapped or enrobed food is air fried at a temperature of about 300° F. to about 450° F. After air-frying, the wrapped or enrobed food may be heated to an average internal temperature of about 140° F. to about 210° F.

The wrapped or enrobed food may be air fried for about 30 seconds to about 15 minutes, about 30 seconds to about 14 minutes, about 30 seconds to about 13 minutes, about 30 seconds to about 12 minutes, about 30 seconds to about 11 minutes, about 30 seconds to about 10 minutes, about 30 seconds to about 9 minutes, about 30 seconds to about 8 minutes, about 30 seconds to about 7 minutes, about 30 seconds to about 6 minutes, about 30 seconds to about 5 minutes, about 30 seconds to about 4 minutes, about 30 seconds to about 3 minutes, about 30 seconds to about 2 minutes, about 30 seconds to about 1 minute, about 1 minute to about 15 minutes, about 2 minutes to about 15 minutes, about 3 minutes to about 15 minutes, about 4 minutes to about 15 minutes, about 5 minutes to about 15 minutes, about 6 minutes to about 15 minutes, about 7 minutes to about 15 minutes, about 8 minutes to about 15 minutes, about 9 minutes to about 15 minutes, about 10 minutes to about 15 minutes, about 11 minutes to about 15 minutes, about 12 minutes to about 15 minutes, about 13 minutes to about 15 minutes, or about 14 minutes to about 15 minutes.

The wrapped or enrobed food may be cooked and/or heated with any means of cooking or heating including, but not limited to, conventional oven, convection oven, broiled, air-fryer, deep-fryer, vacuum-fryer, pan fryer, toaster oven, steamer, roaster, boiler, vacuum cooker, pressure cooker, induction cooker, conduction cooker, microwave, infrared cooker, radio-frequency cooker, and combination cookers like an InstaPot® or Turbo Chef™. One or more of the means of cooking or heating may be used sequentially.

### EXAMPLES

### Example 1: Improved Crispiness with Oxidized Tapioca Starch and Rice Flour

In this Example, several batters were prepared comprising starches and flours to compare the crispiness of each batter. Dumplings were prepared, each having 7.0 grams (g) of filling enclosed in a wrapper that was 3.5 g. The filling was encased in the wrapper and sealed, and then coated in batter. The dumplings were fully cooked. After cooking, the dumplings were frozen for 1 hour in a blast freezer.

Several batters were prepared with varying ingredients. Table 1 shows ten batters that were prepared with various starches, rice flour, combinations thereof, or neither starch nor rice flour. The dumplings were divided into 10 groups, each group consisting of 4 sets of 8 dumplings for a total of 32 dumplings per group, and the dumplings in each group were coated in the respective batter, in accordance with Table 1.

TABLE 1

| Group | Batter components |
|---|---|
| Group 1 | Oxidized tapioca starch + rice flour |
| Group 2 | Hydroxypropyl tapioca starch + rice flour |
| Group 3 | Acetylated tapioca starch + rice flour |
| Group 4 | Native tapioca starch + rice flour |
| Group 5 | Native potato starch + rice flour |
| Group 6 | Native corn starch + rice flour |
| Group 7 | Modified corn starch + rice flour |
| Group 8 | Rice flour |
| Group 9 | Oxidized tapioca starch |
| Group 10 | None (negative control) |

After the dumplings were formed, battered, cooked, and frozen as described above, the dumplings were heated in a 1200 W microwave for 2 minutes. The dumplings were left to sit for 2 minutes after heating, after which the crispiness of the dumplings was measured.

To measure crispiness of the dumplings, a molar head and cup rig was used with a TAXT texture analyzer. Each wonton was placed in the cup rig and crushed with the molar head while the TAXT texture analyzer measured the number of peaks and force generated as the outside of the dumpling was crushed.

The TAXT texture analyzer measures the peak forces generated as the molar head descends and crushes the dumpling. The first four seconds that the dumpling is crushed simulates, in slow motion, a person taking an initial bite of the dumpling as the person's teeth break through the outer crisp batter and wrapper. After four seconds, the peak forces measured by the TAXT texture analyzer no longer reflect the crispiness of only the outer crispy batter because the molar head has encountered the filling of the dumpling. Therefore, to evaluate crispiness of the outside of the dumpling, only the first four seconds of the reading from the TAXT texture analyzer are considered.

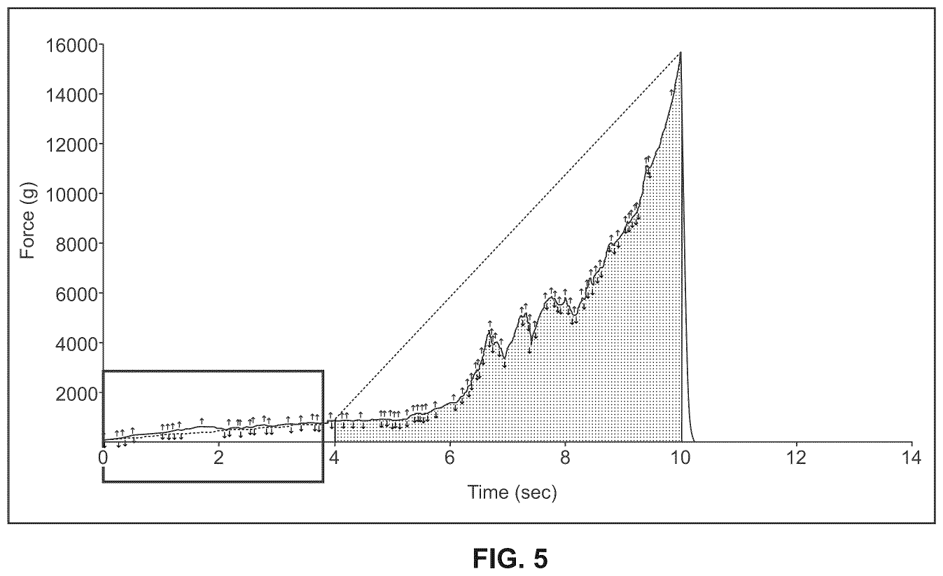

As the TAXT texture analyzer molar head is moving in a downward motion, it comes to the battered wrapper of the dumpling. For each individual dumpling battered in accordance with Table 1, the peak count and the drop off force were measured. Each peak represents a “micro-fracture.” As used herein, average peak count corresponds to the number of micro-factures generated by the crushing of the dumpling measured by the TAXT texture analyzer, averaged over all of the dumplings for each group of batter. Each drop off force represents the magnitude of force to break through a micro-fracture, measured in grams of force over the period. As used herein, average drop off force corresponds to all individual drop off forces, averaged over all of the dumplings for each group of batter. This drop off force can be visualized by graphing the force generated (as measured by the TAXT texture analyzer) relative to the time to generate the force. This is shown in FIG. 5, which shows a sample plot of force vs time for measuring the drop off force when a dumpling is crushed. The first four seconds of the crush performed by the molar rig head (and highlighted in the box on the graph in FIG. 5) represent the initial crunch of the batter and wrapper/dough of the wonton before encountering the filling. After four seconds, the measured force no longer isolates the fracturing of the dumpling batter or wrapper/dough as the molar head has reached the filling of the dumpling.

As shown within the box on the graph in FIG. 5, there are arrows pointing upwardly from the trend line and arrows pointing downwardly from the trend line. An upwardly pointing arrow indicates the build-up in force as the TAXT texture analyzer molar head encounters a micro-fracture zone as it descends at a constant speed through the dumpling. A downwardly pointing arrow indicates the amount of force expended to fracture the micro-fracture zone, referred to as the drop off force. The peak count is indicative of how crispy or crunchy the food item is. A food item with lower peak count is less crispy or crunchy compared to a food item with a higher peak count. The drop off force describes the degree of hardness of each peak. A food item with a small drop off force is brittle or lighter, in other words, easily shattered, in bite compared to a food item with a higher drop off force. A food item with higher drop off force is harder or tougher, in other words, more resilient, in bite.

The average peak force and average drop off force were calculated for each of the Groups shown in Table 1 with different batter compositions. This data is shown in Table 2.

TABLE 2

| | | | Average | |
|---|---|---|---|---|
| | | Average | initial | |
| | | initial | drop off | |
| | | peak | force | |
| Group | Batter Components | count | (grams) | Observations |
| Group 1 | Oxidized tapioca | 34.46 | 60.52 | Crispiest texture |
| | starch + rice flour | | | of all groups |
| Group 2 | Hydroxypropyl tapioca | 14.86 | 122.74 | Lower peak count, |
| | starch + rice flour | | | not as crispy |
| Group 3 | Acetylated tapioca | 10.32 | 15.91 | Low peak count, |
| | starch + rice flour | | | barely crispy, soggy |
| Group 4 | Native tapioca | 25.22 | 21.13 | Fairly crispy but |
| | starch + rice flour | | | hard thin layer |
| Group 5 | Native potato | 18.66 | 46.44 | Tough and sticky in |
| | starch + rice flour | | | texture |
| Group 6 | Native corn | 14.44 | 38.74 | Doughy, hard, |
| | starch + rice flour | | | slightly soggy |
| Group 7 | Modified corn | 9.28 | 23.96 | Slightly hard |
| | starch + rice flour | | | |
| Group 8 | Rice flour | 9.22 | 25.48 | Poor crispiness |
| Group 9 | Oxidized tapioca | 27.23 | 58.42 | Crispy but not as |
| | starch | | | crispy as oxidized |
| | | | | tapioca starch with |
| | | | | rice flour |
| Group | None | 19.63 | 34.53 | Soggy and slightly |
| 10 | (negative control) | | | hard |

As shown in Table 2, the combination in Group 1 of oxidized tapioca starch and rice flour produced the highest average initial peak count and the second highest average initial drop off force of all ten groups. While Group 2 with hydroxypropyl tapioca starch and rice flour produced a larger average initial drop off force, the average initial peak count for Group II was less than half of that in Group 1, indicating that hydroxypropyl tapioca starch does not generate as crispy of a batter coating as oxidized tapioca starch.

Group 4 with native (i.e., unmodified) tapioca starch and rice flour was significantly less crispy than Group 1 with oxidized tapioca starch and rice flour. This demonstrated that native tapioca starch does not impart the same crispiness as oxidized tapioca starch, even combined with rice flour. Further, not all modified tapioca starch demonstrated the improved crispiness as in Group 1. Groups 2 and 3 included hydroxypropyl and acetylated modified tapioca starches with rice flour, respectively, however, these groups had a lower average initial peak count than native tapioca starch with rice flour. This demonstrates that not all modified tapioca starch improves crispiness, but rather, only oxidized tapioca starch with rice flour demonstrated improved crispiness as compared to native tapioca starch and rice flour.

The results of Example 1 demonstrate that the combination of oxidized tapioca starch and rice flour produces a dumpling (or other enrobed food product) with the crispiest batter coating, even after microwaving the dumpling. Additionally, the combination of oxidized tapioca starch and rice flour produces a crispier batter coating than either ingredient alone.

### Example 2: Comparing Flours in the Batter

In this Example, multiple batters were prepared with different kinds of flour to evaluate how flour type impacts crispiness. Thirty-two samples of each of the three batters were prepared as described in Table 3.

TABLE 3

| | | | | Average | |
|---|---|---|---|---|---|
| | | | Average | initial | |
| | | | initial | drop off | |
| | Type of | Protein | peak | force | |
| Group | flour | content | count | (grams) | Observations |
| A | Soft wheat | 7-8% | 34.46 | 60.52 | Crispy, thin, and |
| | cake flour | | | | light batter |
| B | Baker's | 12-14% | 18.40 | 27.85 | Thick and doughy |
| | flour | | | | |
| C | All-purpose | 9-12% | 22.66 | 41.10 | Thick and doughy |
| | flour | | | | but slightly softer |
| | | | | | than Baker's flour |

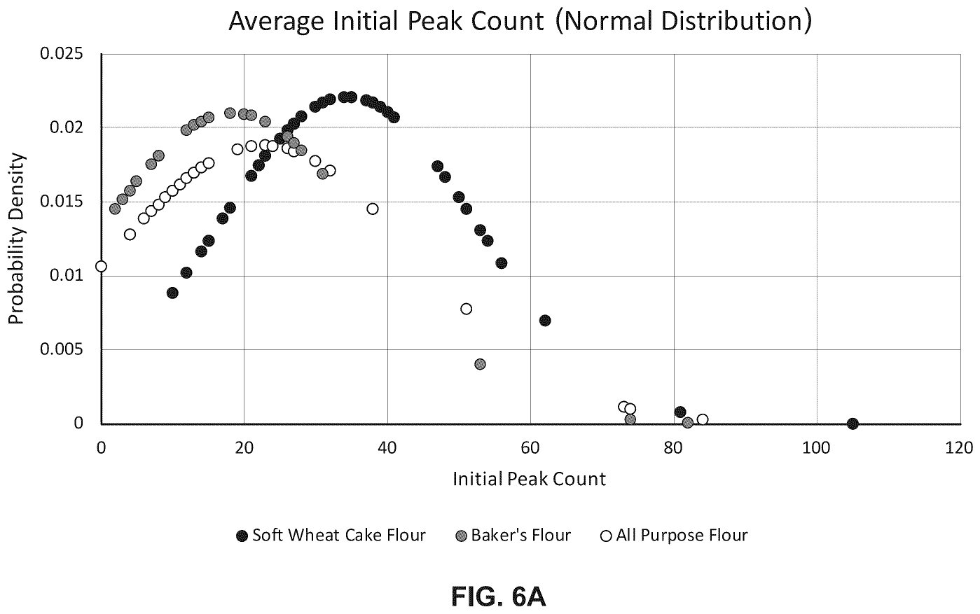

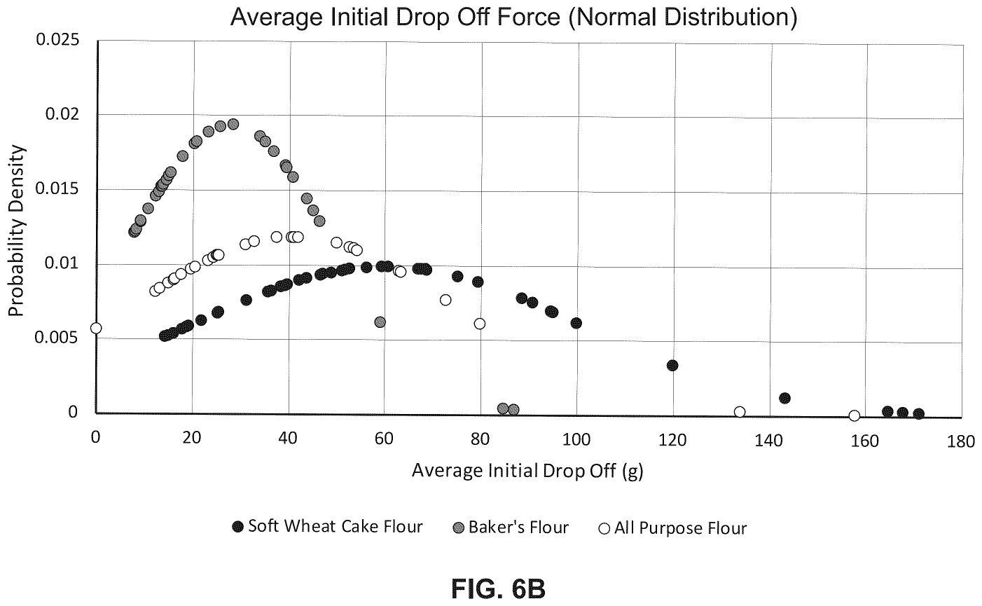

FIGS. 6A and 6B show plots of the average initial peak count and average initial drop off force for Groups A, B, and C. The average initial peak count and average initial drop off force were measured and calculated in accordance with the equipment and methods described in Example 1.

As shown in FIG. 6A and in Table 3, the batter with soft wheat cake flour had a higher average initial peak count of 34.46 as compared to the Baker's flour and all-purpose flour, which had averages of about 18.40 and 22.66, respectively. As shown in FIG. 6B, the batter coating with cake flour had a higher average initial drop off force of 60.52 grams as compared to Baker's flour and all-purpose flour, which had averages of about 27.85 grams and 41.10 grams, respectively.

The results of Example 2 demonstrate that soft wheat cake flour produced a batter that is crispy, thin, and light, as evidenced by the highest average initial peak count (i.e., 34.46) and the highest average initial drop off force (i.e., 60.52 grams). Batters made with Baker's flour and all-purpose flour were soggier and thicker as compared to soft wheat cake flour.

### Example 3: Evaluating Crispiness with Different Cooking Methods

As discussed herein, it may be desirable for consumers to produce a crispy enrobed food product without relying on traditional, time-consuming methods such as oven baking. In this Example, the crispiness of dumplings (as prepared according to the present disclosure) was measured by heating the dumplings by microwaving, deep-frying, air-frying, oven-baking, and steaming.

Table 4 shows guidelines for determining if a dumpling, or other enrobed food product, is crispy using the average initial peak count and average initial drop off force. These classifications were used to categorize the dumplings prepared by the five heating methods.

TABLE 4

| | | Average initial drop off |
|---|---|---|
| Classification | Average initial peak count | force (g) |
| Hard | <15 | >60 |
| Crunchy | >40 | >60 |
| Crispy | 20-40 | 40-60 |
| Slightly crispy | 15-35 | 20-40 |
| Flaky, pastry-like | >40 | <20 |
| Soggy | <15 | <20 |

Dumplings were heated in the 1200 W microwave as follows: the dumplings were placed on a microwave-safe plate with a paper towel, microwaved for 3 minutes on high, and left to sit for 2 minutes.

Dumplings were heated in the deep fryer as follows: oil was pre-heated to 350° F. and the dumplings were fried for 3 minutes in a fryer basket in the oil.

Dumplings were heated in the air-fryer as follows: the air-fryer was pre-heated to 390° F. and the dumplings were heated in the air-fryer for 6 minutes.

Dumplings were heated in the oven as follows: a toaster oven was set to “convection” and pre-heated to 425° F. The dumplings were placed on a baking sheet and heated for 10 minutes.

Dumplings were heated by steaming as follows: a steamer basket was filled with water and brought to a boil. The dumplings were placed in the steamer basket and cooked for 6 minutes.

The average initial peak count and average initial drop off force were measured for the dumplings heated with the above methods. The average initial peak count and average initial drop off force were measured in accordance with the equipment and methods described in Example 1.

Table 5 shows the average initial peak count and average initial drop off force for all five heating methods.

TABLE 5

| | Average | Average | |
|---|---|---|---|
| | initial | initial | |
| | peak | drop off | |
| Heating method | count | force (grams) | Observations |
| Microwaved | 34.46 | 60.52 | Crispy, slightly hard bite |
| | | | with fractures of outer |
| | | | layer |
| Deep fried | 28.16 | 47.50 | Crispy and juicy with |
| | | | tender crunch |
| Air fried | 24.00 | 45.69 | Crispy and juicy, similar |
| | | | to deep fried |
| Oven baked | 15.13 | 35.02 | Softer bite with less |
| | | | crunch, softer after |
| | | | initial bite |
| Steamed | 1.13 | 7.08 | Soggy, wet, soft |

Microwaving, deep-frying, and air-frying produced dumplings with relatively similar average initial peak counts, indicating comparable crispiness between the deep-fried, the air-fried, and the microwaved dumplings prepared using the compositions and methods described herein.

The results of Example 3 further show that the microwaved dumpling prepared in accordance with the compositions and methods described herein satisfies the requirements in Table 4 for a crispy outer layer. Microwaving the dumpling as described herein produces a final product for consumption that is comparable in crispiness compared to dumplings heated by deep-frying and air-frying, and produced dumplings that are crispier than oven-baking.

### Example 4: Battered Vs Unbattered Dumplings

In this Example, dumplings were prepared in accordance with the compositions and methods described herein to compare the crispiness of battered vs unbattered dumplings. Half of the dumplings were battered in accordance with the batters and methods described herein, and half of the dumplings remained unbattered.

The assembled dumplings were cooked, heated, and analyzed with the TAXT texture analyzer as described in Example 1. The average initial peak count and average initial drop off force were measured as described in Example 1 and shown in Table 6.

TABLE 6

| | | Average | |
|---|---|---|---|
| | Average | initial | |
| | initial | drop off | |
| | peak | force | |
| Type | count | (grams) | Observations |
| Battered | 34.46 | 60.52 | Crispy, thin, light |
| Unbattered | 12.72 | 29.79 | Soft, crisp only on edge of dumpling |
| | | | and has hard and dry crunch |

The battered product had an average initial peak count more than double than the peak count of the unbattered dumpling and an average initial drop off force double than the unbattered dumpling.

The results of this Example demonstrate that a dumpling (or other enrobed product) battered in accordance with the present disclosure is significantly crispier than an unbattered dumpling after microwaving and resting. In contrast, the unbattered dumpling remained soggy while the wings of the wrapper extending from the body of the dumpling became hard and dry after microwaving.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A microwavable crispy dumpling comprising:
a dumpling wrapper comprising dough;
a batter comprising one or more of soft wheat cake flour, oxidized tapioca starch, and rice flour; and
a filling.

2. The microwavable crispy dumpling of claim 1, wherein the dumpling has 2 creases to 12 creases.

3. The microwavable crispy dumpling of claim 1, wherein the batter comprises soft wheat cake flour, oxidized tapioca starch, and rice flour.

4. The microwavable crispy dumpling of claim 1, wherein the dumping wrapper has a thickness of about 0.2 mm to about 12.0 mm.

5. The microwavable crispy dumpling of claim 1, wherein the batter has a consistency of about 5 cm to about 30 cm as measured by a Bostwick consistometer at 30 seconds.

6. The microwavable crispy dumpling of claim 1, wherein the batter has a consistency of about 15 cm to about 17 cm as measured by a Bostwick consistometer at 30 seconds.

7. The microwavable crispy dumpling of claim 1, wherein the dumpling is cooked by boiling, steaming, pan-frying, deep-frying, air-frying, vacuum frying, baking, convection, broiling, toasting, roasting, microwaving, infrared, radio frequency, induction, conduction, pressure cooking, vacuum cooking, or combinations thereof.

8. The microwavable crispy dumpling of claim 1, wherein the dumpling is frozen before cooking, after cooking, or after partial cooking.

9. A method of making a microwavable crispy dumpling, the method comprising:
a) mixing ingredients to form a dough;
b) preparing a dumpling wrapper from the dough;
c) filling the dumpling wrapper;
d) forming a dumpling; and
(e) coating the dumpling in a batter, the batter comprising at least one of soft wheat cake flour, oxidized tapioca starch, and rice flour.

10. The method of claim 9, wherein the dumpling has 2 creases to 12 creases.

11. The method of claim 9, wherein the dumpling batter coating comprises soft wheat cake flour, oxidized tapioca starch, and rice flour.

12. The method of claim 9, wherein the dumping wrapper has a thickness of about 0.2 mm to about 12.0 mm.

13. The method of claim 9, wherein the batter has a consistency of about 10 cm to about 30 cm as measured by a Bostwick consistometer at 30 seconds.

14. The method of claim 9, wherein the batter has a consistency of about 15 cm to about 17 cm as measured by a Bostwick consistometer at 30 seconds.

15. The method of claim 9, further comprising the step of cooking the dumpling after step e).

16. The method of claim 15, wherein the dumpling is cooked by boiling, steaming, pan-frying, deep-frying, air-frying, vacuum frying, baking, convection, broiling, toasting, roasting, microwaving, infrared, radio frequency, induction, conduction, pressure cooking, vacuum cooking, or combinations thereof.

17. The method of claim 9, wherein the dumpling is frozen before cooking, after cooking, or after partial cooking.

18. The method of claim 9, further comprising the step of microwaving the dumpling after step e).

19. The method of claim 18, wherein the dumpling is microwaved for 10 seconds to 15 minutes.
